(19) United States
(12) Patent Application Publication
(10) Pub. No.: US 2025/0004831 A1
(43) Pub. Date: Jan. 2, 2025

(54) SYSTEM AND METHOD FOR OPERATING A HARDWARE WATCHDOG TIMER IN A DATA PROCESSING UNIT

(71) Applicant: VMWARE, INC., Palo Alto, CA (US)

(72) Inventors: Sunil Kumar Kotian, San Jose, CA (US); Adithya Uligere Narasimhamurthy, Longmont, CO (US)

(21) Appl. No.: 18/217,466

(22) Filed: Jun. 30, 2023

(51) Int. Cl. G06F 9/48

(52) U.S. Cl. CPC G06F 9/4887; G06F 9/4825

(57) ABSTRACT

System and computer-implemented method enables a hardware watchdog timer in a data processing unit (DPU) and detects that a host server that is connected to the DPU is unresponsive when the hardware watchdog timer expires without receiving a timer reset request from a host watchdog service timer thread running in the host server.

### BACKGROUND

Data processing units (DPUs), which may also be referred to as SmartNICs (NIC stands for Network Interface Card) or infrastructure processing units (IPUs), can be integrated into a network device, for example, a network adapter, to perform various operations, such as Input/Output (I/O) operations, storage operations, network service operations, and/or security operations. DPUs are typically connected to a host server over a network interface, such as a Peripheral Component Interconnect Express (PCIe) interface and are primarily managed by the host server that acts similarly to a master. A host server can monitor the health, life cycles and power cycles of DPUs that are connected to the host server. When a DPU encounters an irrecoverable exception or otherwise becomes unresponsive, a connected host server or baseboard management controller (BMC) can detect a missing heartbeat from the DPU and take remedial actions, which include resetting the DPU.

However, it is generally challenging for a DPU to know when a corresponding host server fails and becomes unresponsive. In addition, a failed host server may eventually reboot or power cycle. However, to restore to a fully operational state, a host server subsequently needs to reboot the DPU as well, which can not only leave the DPU in an unpredictable operational state, causing thermal and safety vulnerabilities, but also add to the overall latency in a recovery path.

### SUMMARY

System and computer-implemented method enables a hardware watchdog timer in a DPU and detects that a host server that is connected to the DPU is unresponsive when the hardware watchdog timer expires without receiving a timer reset request from a host watchdog service timer thread running in the host server.

A computer-implemented method in accordance with an embodiment of the invention comprises at a DPU, enabling a hardware watchdog timer in the DPU and at the hardware watchdog timer in the DPU, detecting that a host server that is connected to the DPU is unresponsive when the hardware watchdog timer expires without receiving a timer reset request from a host watchdog service timer thread running in the host server. In some embodiments, the steps of this method are performed when program instructions contained in a computer-readable storage medium are executed by one or more processors.

A system in accordance with an embodiment of the invention comprises memory and at least one processor configured to enable a hardware watchdog timer in a DPU and detect that a host server that is connected to the DPU is unresponsive when the hardware watchdog timer expires without receiving a timer reset request from a host watchdog service timer thread running in the host server.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a computing system with a host server and at least one DPU in accordance with an embodiment of the invention.

FIG. 2 is a process flow diagram of a process of a host-based hardware watchdog timer operation in the computing system depicted in FIG. 1 that includes the host server and the DPU in accordance with an embodiment of the invention.

FIG. 3 is a process flow diagram of a process of another host-based hardware watchdog timer operation in the computing system depicted in FIG. 1 that includes the host server and the DPU in accordance with an embodiment of the invention.

FIG. 4 depicts an embodiment of a hardware watchdog timer in the DPU of the computing system depicted in FIG. 1.

FIG. 5 is a flow diagram of a computer-implemented method in accordance with an embodiment of the invention.

FIG. 6 is a flow diagram of a computer-implemented method in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

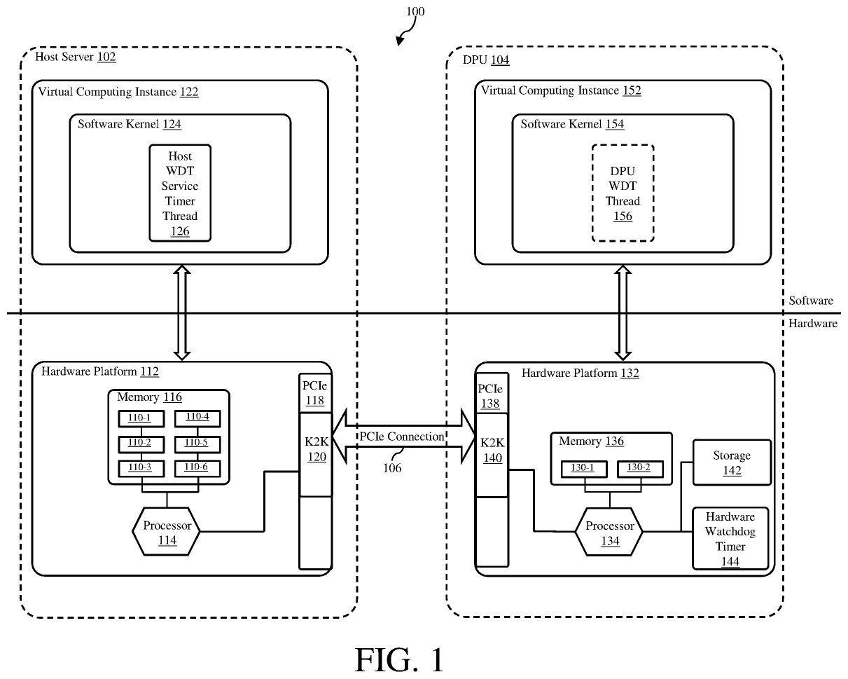

Turning now to FIG. 1, a computing system 100 in accordance with an embodiment of the invention is illustrated. The computing system 100 includes a host server 102 and at least one DPU 104. As described in detail below, communication is conducted between the host server 102 and the DPU 104 via a PCIe connection 106 so that the host server 102 can communicate with the DPU 104 for various operations. In some embodiments, the DPU 104 is managed by the host server 102, and thus, the communication connections are used by the host server 102 to access the DPU 104 to execute management operations.

The host server 102 may be constructed on a hardware platform 112, which can be a computer hardware platform, such as an x86 architecture platform. As shown, the hardware platform of the host server 102 may include components of a computing device, such as one or more processors (e.g., central processing units (CPUs)) 114, one or more memory 116, and a network interface 118. The processor 114 can be any type of a processor commonly used in computers or servers. The memory 116 can be volatile memory used for retrieving programs and processing data. The memory 116 may include memory units 110-1, 110-2, 110-3, 110-4, 110-5, 110-6, which may be, for example, random access memory (RAM) modules. However, in other embodiments, the memory 116 may include more than or less than six memory units. The network interface 118, which may be a PCIe interface, enables the host server to communicate with the DPU 104 via a communication medium, such as a network cable. The network interface 118 may include one or more network adapters, also referred to as network interface cards (NICs). In some embodiments, the network interface 118 includes a kernel-to-kernel (K2K) interface 120 that enables the host server to communicate with the DPU 104 for internal kernel-to-kernel communication. In some embodiments, the host server includes storage that may include one or more local storage devices (e.g., one or more hard disks, flash memory modules, solid state disks and/or optical disks), which may be used to form a virtual storage area network (SAN).

The host server 102 may be configured to provide a virtualization layer that abstracts processor, memory, storage and networking resources of the hardware platform 112 into at least one virtual computing instance 122. The virtual computing instance 122 may be a virtual host, for example, a VMware ESXi™ host. In the illustrated embodiment, the virtual computing instance 122 includes a software kernel 124, for example, a VMware ESXi™ kernel configured or programmed to execute various operations. As an example, the software kernel 124 may be configured or programmed to deploy, update, delete and otherwise manage components in the host server 102 and/or the DPU 104. The software kernel 124 can execute software instructions. For example, the software kernel 124 may execute or host a software thread, for example, a host watchdog timer (WDT) service timer thread 126. In some embodiments, the virtual computing instance 122 includes a virtual machine that runs on top of a software interface layer, which is referred to herein as a hypervisor. One example of the hypervisor that may be used in an embodiment described herein is a VMware ESXi™ hypervisor provided as part of the VMware vSphere® solution made commercially available from VMware, Inc. The hypervisor may run on top of the operating system of the host server 102 or directly on hardware components of the host server 102. For other types of virtual computing instances, the host server 102 may include other virtualization software platforms to support those virtual computing instances, such as Docker virtualization platform to support “containers.”

The DPU 104 may be constructed on a hardware platform 132, which can be a computer hardware platform. As shown, the hardware platform of the DPU 104 may include components of a computing device, such as one or more processors (e.g., CPUs or microcontrollers) 134, one or more memory 136, a network interface 138, a storage 142, and a hardware watchdog timer 144. The processor 134 can be any type of a processor commonly used in computers or devices. The memory 136 can be volatile memory used for retrieving programs and processing data. The memory 136 may include memory units 130-1, 130-2, which may be, for example, RAM modules. However, the memory 136 may include more than or less than two memory units. The network interface 138, which may be a PCIe interface, enables the DPU 104 to communicate with the host server 102 via a communication medium, such as a network cable. The network interface 138 may include one or more network adapters, also referred to as NICs. In some embodiments, the network interface 138 includes a K2K interface 140 that enables the DPU 104 to communicate with the host server 102 for internal kernel-to-kernel communication. In some embodiments, the storage 142 may include one or more local storage devices (e.g., one or more hard disks, flash memory modules, embedded MultiMediaCards (eMMCs), solid state disks (SSDs) and/or optical disks. The hardware watchdog timer (WDT) 144, which is also referred to as the hardware watchdog, contains hardware configured to perform a corrective action, e.g., to reset the DPU in the event of a hard system lockup. For example, the hardware watchdog timer 144 can be regularly reset or restarted to prevent it from elapsing or timing out. However, if the hardware watchdog timer 144 fails to be reset or restarted before the hardware watchdog timer 144 elapses, the hardware watchdog timer 144 can generate a timeout signal to initiate one or more corrective actions. Examples of the corrective actions include, but not limited to, resetting the DPU, resetting the host server and generating an interrupt. In some embodiments, the hardware watchdog timer 144 is used to detect if the host server 102 fails or otherwise becomes unresponsive. The hardware watchdog timer 144 may be configured, programmed, or set with a timeout value. The hardware watchdog timer 144 can be enabled/disabled as needed, for example, from within an operating system (OS) of the DPU 104 by, e.g., the processor 134. For example, the hardware watchdog timer 144 of the DPU 104 may be enabled during the bootup of the DPU 104 and programmed or set to have a desired timeout value, for example, a 4-minute timeout period. In this example, the hardware watchdog timer 144 can be regularly reset or restarted within the 4-minute timeout period to prevent it from elapsing or timing out. However, if the hardware watchdog timer 144 fails to be reset or restarted before the 4-minute timeout period elapses, the hardware watchdog timer 144 can generate a timeout signal to initiate one or more corrective actions. The time period of the hardware watchdog timer 144 can be set to any suitable value, and is not limited to the examples described herein. In some embodiments, the hardware watchdog timer 144 is configured or programmed to issue or generate a reset signal to reset the DPU 104.

The DPU 104 may be configured to provide a virtualization layer that abstracts processor, memory, storage and networking resources of the hardware platform 132 into at least one virtual computing instance 152. The virtual computing instance 152 may be a virtual agent, for example, a VMware ESXio agent. In the illustrated embodiment, the virtual computing instance 152 includes a software kernel 154, for example, a VMware ESXio kernel configured or programmed to execute various operations. As an example, the software kernel 154 may be configured or programmed to deploy, update, delete and otherwise manage components in the DPU 104. The software kernel 154 can execute software instructions. For example, the software kernel 154 may execute or host a software thread, for example, a DPU watchdog timer (WDT) thread 156. In the computing system 100 depicted in FIG. 1, the K2K interface 120 of the host server 102 may communicate with the K2K interface 140 of the DPU 104 for internal communication between the software kernel 124 of the host server 102 and the software kernel 154 of the DPU 104.

In a typical DPU implementation, a watchdog service timer thread or process is entirely local to a DPU. Specifically, a DPU watchdog timeout is detected by executing a DPU watchdog service timer thread or process in the DPU. For example, a DPU hardware watchdog is enabled during a bootup of a DPU and programmed to a desired timeout value, and a watchdog service timer thread or process of the DPU hardware watchdog is created in the DPU at a suitable priority and timeout to reset a timeout timer in the hardware watchdog. In a typical DPU watchdog timeout detection procedure, a DPU watchdog is only used to detect DPU related lockups/error conditions. A DPU watchdog generally is not aware of when a corresponding host server fails and becomes unresponsive.

In accordance with an embodiment of the invention, by using a host-based watchdog service timer (e.g., the host WDT thread 126), the watchdog service responsibility is moved from the DPU 104 to the host server 102. The host server can create a watchdog service timer thread (e.g., the host WDT thread 126), for example, by using a general-purpose timer to serve as the watchdog service timer. When a watchdog service timer expires, the host server can send instructions to the DPU to service or reset the hardware watchdog timer 144. When the DPU receives the instructions from the host server, the DPU restarts or resets the hardware watchdog timer to resume at the original timeout value. Consequently, the hardware watchdog timer can detect that the host server 102 is unresponsive when the hardware watchdog timer expires without receiving any timer reset request from a watchdog service timer thread (e.g., the host WDT thread 126) of the host server. Because the hardware watchdog timer is aware of the operation status of the watchdog service timer thread (e.g., the host WDT thread 126) of the host server as well as the operation status of the host server, the hardware watchdog timer can detect when the host server becomes unresponsive. Consequently, the hardware watchdog timer can reset the DPU 104 when the host server fails and becomes unresponsive.

A watchdog service timer thread (e.g., the host WDT thread 126) can be created on the host server at a suitable priority and timeout. For example, the timeout period of the watchdog service timer thread may be chosen to be half of the timeout period of the hardware watchdog timer 144. The priority of the watchdog service timer thread (e.g., the host WDT thread 126) can be chosen at medium priority such that any lockups in higher threads are detected by failing to schedule the watchdog service timer thread, which eventually results in a watchdog timeout and reset of the hardware watchdog timer 144. When the host server 102 is unresponsive, the watchdog service timer thread (e.g., the host WDT thread 126) of the host server will fail to service the hardware watchdog timer 144 and the DPU will be reset. In some embodiments, the host server is also reset, thus recovering the host server that is in an unpredictable operational state. If the watchdog service timer thread (e.g., the host WDT thread 126) of the host server tries to service the hardware watchdog timer 144 and the DPU is in an unpredictable operational state, an existing heartbeat mechanism can be used to detect DPU lockups, and use of an additional mechanism such as watchdog is not required. For example, for the DPU, the host server behaves similarly to a watchdog and the periodic heartbeat from the DPU to the host server is similar to watchdog servicing and an additional hardware watchdog on the DPU is redundant. The DPU 104 can not only enable the hardware watchdog timer 144, but also inform the host server 102 of a boot completion event, followed by a watchdog capabilities event informing the host server 102 whether the hardware watchdog timer 144 is available and what the maximum possible timeout is. The host server 102 can send instructions to the DPU 104 to enable the hardware watchdog timer 144 with a desired timeout value, and the DPU enables the hardware watchdog timer 144 accordingly and responds back with success/failure information to the host server.

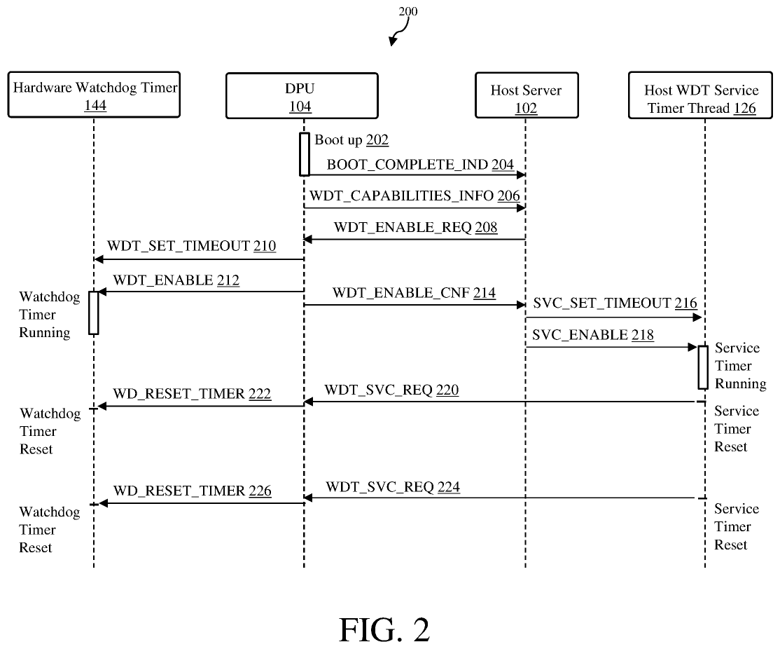

A process of host-based DPU hardware watchdog time operation in the computing system 100 in accordance with an embodiment of the invention is described with reference to a swim-lane diagram 200 shown in FIG. 2. In the swim-lane diagram 200 illustrating an example procedure for host-based watchdog management in the computing system 100 that includes the host server 102 and the DPU 104, the hardware watchdog timer 144 is not only used to detect DPU related lockups/error conditions, but also used to detect when the host server 102 fails and becomes unresponsive.

The process begins in operation 202 in which the DPU 104 boots up. After bootup, in operation 204, the DPU transmits a bootup completion indication signal BOOT_COMPLETE_IND to the host server 102 to notify the host server that the bootup of the DPU 104 is completed, for example, through the PCIe connection 106. Next, in operation 206, the DPU transmits a watchdog capability information signal WDT_CAPABILITIES_INFO to the host server 102 to notify the host server 102 of the capabilities (e.g., the timeout period) of the hardware watchdog timer 144 of the DPU 104, for example, through the PCIe connection 106. In some embodiments, typical Watchdog capabilities can be defined as follows:

typedef struct watchdog_capabilities
{
Const BOOL watchdog_present; //TRUE or FALSE
Const Uint64 Watchdog_timeout_max_ms; //maximum timeout in
milliseconds
Const Uint64 Watchdog_password;//optional 64bit key to identify the
host for security
Const BOOL watchdog_running;//TRUE or FALSE
Const wdt_operations_t watchdog_operations;//permitted WDT
operations see below
}watchdog_capabilities_info;
typedef enum
{
WDT_DISABLE_REQ; //turn off the watchdog
WDT_ENABLE_REQ;//turn on the watchdog
WDT_SET_TIMEOUT;//set or change the timeout value in milliseconds
WDT_SVC_REQ;//restarts the watchdog and resumes from 0 to count till
timeout_ms
}
wdt_operations_t.

In response, in operation 208, the host server transmits a watchdog enablement request signal WDT_ENABLE_REQ to the DPU 104 to start the enablement process of the hardware watchdog timer 144 of the DPU 104, for example, through the PCIe connection 106. Upon receiving the watchdog enablement request signal WDT_ENABLE_REQ, the DPU 104 (e.g., the processor 134) transmits a watchdog timeout setup signal WDT_SET_TIMEOUT to the hardware watchdog timer 144 to configure, program, or setup the timeout period of the hardware watchdog timer 144 in operation 210. Subsequently, in operation 212, the DPU 104 (e.g., the processor 134) transmits a watchdog enablement signal WDT_ENABLE to the hardware watchdog timer 144 to enable the hardware watchdog timer 144 to start the hardware watchdog timer 144 with the configured timeout period (e.g., to count to zero or other predefined threshold value in the configured timeout period), and in operation 214, the DPU 104 transmits a watchdog enablement confirmation signal WDT_ENABLE_CNF to the host server 102 to inform the host server 102 that the hardware watchdog timer 144 has been enabled, for example, through the PCIe connection 106. For example, the hardware watchdog timer 144 of the DPU 104 is enabled during the bootup of the DPU 104 and is programmed or set to have a desired timeout value, for example, a 4-minute timeout period.

In operation 216, the host server 102 (e.g., the processor 114) transmits a service timer timeout setup signal SVC_SET_TIMEOUT to the host WDT thread 126 to configure, program, or setup the timeout period for the host WDT thread 126. Subsequently, in operation 218, the host server 102 (e.g., the processor 114) transmits a service timer enablement signal SVC_ENABLE to the host WDT thread 126 to enable the host WDT thread 126 to start a timeout timer with the configured timeout period (e.g., to count to zero or other predefined threshold value in the configured timeout period). For example, the host WDT thread 126 is enabled and is programmed or set to have a desired timeout value, for example, a 2-minute timeout period.

Next, in operation 220, after the timeout timer of the host WDT thread 126 expires (e.g., the predefined timeout period of the timeout timer elapses), the host WDT thread 126 transmits a watchdog service timer request signal WDT_SVC_REQ to the DPU 104 to start the timer reset process of the hardware watchdog timer 144 of the DPU 104, and in operation 222, the DPU 104 transmits a watchdog timer reset signal WDT_RESET_TIMER to the hardware watchdog timer 144 to reset the hardware watchdog timer 144 back to its original timeout value. For example, the host WDT thread 126 transmits the watchdog service timer request signal WDT_SVC_REQ to the DPU 104 after a 2-minute timeout period, and because the hardware watchdog timer 144 has a longer timeout period (e.g., a 4-minute timeout period), the hardware watchdog timer 144 can be reset to its original timeout value (e.g., a 4-minute timeout period) before the hardware watchdog timer 144 expires.

Subsequently, the timeout timer of the host WDT thread 126 is reset, and in operation 224, after the timeout timer of the host WDT thread 126 expires again (e.g., the predefined timeout period of the timeout timer elapses again), the host WDT thread 126 transmits a watchdog service timer request signal WDT_SVC_REQ to the DPU 104 to start the timer reset process of the hardware watchdog timer 144 of the DPU 104 again, and in operation 226, the DPU 104 transmits a watchdog timer reset signal WDT_RESET_TIMER to the hardware watchdog timer 144 to reset the hardware watchdog timer 144 back to its original timeout value again. For example, the host WDT thread 126 transmits the watchdog service timer request signal WDT_SVC_REQ to the DPU 104 after a 2-minute timeout period, and because the hardware watchdog timer 144 has a longer timeout period (e.g., a 4-minute timeout period), the hardware watchdog timer 144 can be reset to its original timeout value (e.g., a 4-minute timeout period) before the hardware watchdog timer 144 expires. By resetting the hardware watchdog timer 144 to its original timeout value based on the notification of the elapse of shorter timeout period of the host WDT thread 126, the hardware watchdog timer 144 is aware of the operation status of the host WDT thread 126 as well as the operation status of the host server 102.

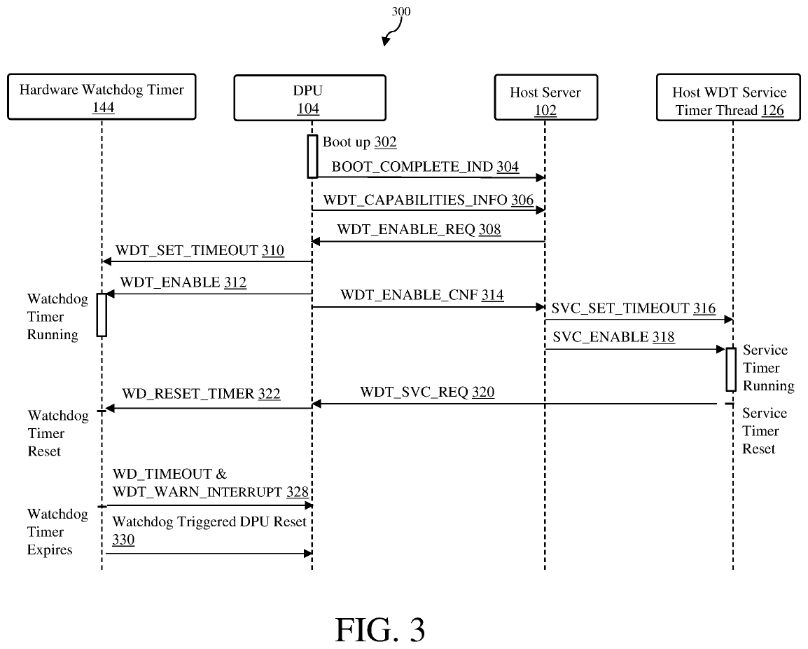

A process of another host-based DPU hardware watchdog timer operation in the computing system 100 in accordance with an embodiment of the invention is described with reference to a swim-lane diagram 300 shown in FIG. 3. In the swim-lane diagram 300 illustrating an example procedure for host-based watchdog reset in the computing system 100 that includes the host server 102 and the DPU 104, the hardware watchdog timer 144 is not only used to detect DPU related lockups/error conditions, but also used to detect when the host server 102 fails and becomes unresponsive using the host WDT thread 126 and to reset the DPU 104. Operations 302-322 in the swim-lane diagram 300 depicted in FIG. 3 are identical with operations 202-222 in the swim-lane diagram 200 depicted in FIG. 2. The difference between the operations in the swim-lane diagram 300 depicted in FIG. 3 and the operations in the swim-lane diagram 200 depicted in FIG. 2 is that the hardware watchdog timer 144 detects that the host server 102 is unresponsive when the hardware watchdog timer expires without receiving any timer reset request from the host watchdog service timer thread 126 of the host server 102. Specifically, starting from operation 328, the hardware watchdog timer 144 transmits a watchdog timer timeout signal WDT_TIMEOUT and a watchdog waring interrupt signal WDT_WARN_INTERRUPT to the DPU 104 (e.g., the processor 134) to start the reset process of the DPU 104. Subsequently, in operation 330, the hardware watchdog timer 144 transmits a watchdog triggered DPU reset signal to the DPU 104 (e.g., the processor 134) to reset the DPU 104. Because the hardware watchdog timer 144 is aware of the operation status of the host WDT thread 126 as well as the operation status of the host server, the hardware watchdog timer 144 can detect that the host server 102 becomes unresponsive when the hardware watchdog timer expires without receiving any timer reset request from the host WDT thread 126 of the host server. Consequently, the hardware watchdog timer can reset the DPU when the host server fails and becomes unresponsive. In some embodiments, the hardware watchdog timer 144 is configured or programmed to send a message to a corresponding BMC, when the host server 102 fails and becomes unresponsive (e.g., when the hardware watchdog timer 144 is not reset to its original timeout value before the hardware watchdog timer 144 expires).

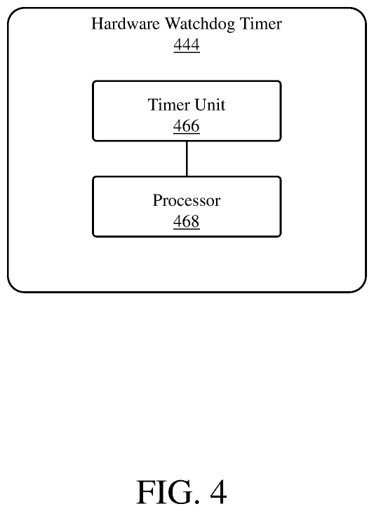

FIG. 4 depicts a hardware watchdog timer 444, which is an embodiment of the hardware watchdog timer 144 of the DPU 104 of the computing system 100 depicted in FIG. 1. However, the hardware watchdog timer 144 depicted in FIG. 1 is not limited to the embodiment depicted in FIG. 4. In the embodiment depicted in FIG. 4, the hardware watchdog timer 444 includes a timer unit 466 and a processor 468. The timer unit 466 may be implemented in hardware, software, and/or firmware. In some embodiments, the timer unit 466 may be a stopwatch that counts down from an original timeout value to zero or other predefined value, which can trigger a warning or control signal. The processor 468 may be implemented as at least one processor (e.g., a microcontroller, a DSP, and/or a CPU). The processor 468 may be configured to reset the timer unit 466 to the original timeout value and/or to generate a warning or control signal when the timeout value of the timer unit 466 is counted down to zero or other predefined value (i.e., the hardware watchdog timer 444 is expired) without being reset to the original timeout value. Although the hardware watchdog timer 444 is shown in FIG. 4 as including certain elements, in other embodiments, the hardware watchdog timer 444 may include more or less elements to implement more or less functions.

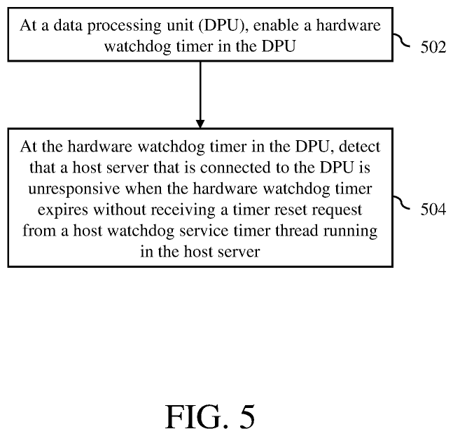

A computer-implemented method in accordance with an embodiment of the invention is described with reference to a process flow diagram of FIG. 5. At block 502, at a DPU, a hardware watchdog timer in the DPU is enabled. At block 504, at the hardware watchdog timer in the DPU, that a host server that is connected to the DPU is unresponsive is detected when the hardware watchdog timer expires without receiving a timer reset request from a host watchdog service timer thread running in the host server.

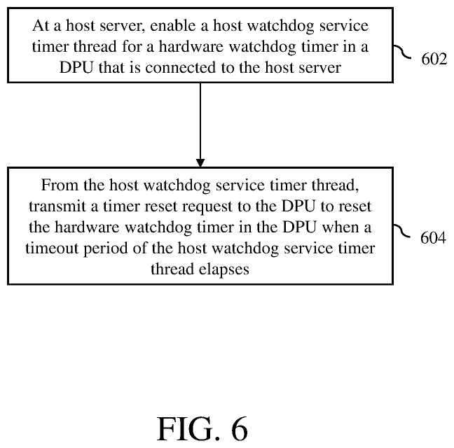

A computer-implemented method in accordance with an embodiment of the invention is described with reference to a process flow diagram of FIG. 6. At block 602, at a host server, a host watchdog service timer thread for a hardware watchdog timer in a DPU that is connected to the host server is enabled. At block 604, from the host watchdog service timer thread, a timer reset request is transmitted to the DPU to reset the hardware watchdog timer in the DPU when a timeout period of the host watchdog service timer thread elapses.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer usable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method comprising:
at a data processing unit (DPU), enabling a hardware watchdog timer in the DPU; and
at the hardware watchdog timer in the DPU, detecting that a host server that is connected to the DPU is unresponsive when the hardware watchdog timer expires without receiving a timer reset request from a host watchdog service timer thread running in the host server.

2. The computer-implemented method of claim 1, further comprising, at the hardware watchdog timer running in the DPU, resetting the DPU after detecting that the host server that is connected to the DPU is unresponsive.

3. The computer-implemented method of claim 1, further comprising, at the hardware watchdog timer, transmitting an interrupt signal to the DPU after detecting that the host server that is connected to the DPU is unresponsive.

4. The computer-implemented method of claim 1, further comprising:
at the DPU, transmitting a bootup completion indication signal to the host server to notify the host server that a bootup of the DPU is completed; and
at the DPU, transmitting a watchdog capability information signal to the host server to notify the host server of capability information of the hardware watchdog timer in the DPU.

5. The computer-implemented method of claim 1, wherein enabling the hardware watchdog timer in the DPU comprises:
at the DPU, receiving a watchdog enablement request signal from the host server; and
upon receiving the watchdog enablement request signal, configuring a timeout period of the hardware watchdog timer in the DPU and enabling the hardware watchdog timer in the DPU.

6. The computer-implemented method of claim 1, further comprising:
at the DPU, transmitting a watchdog enablement confirmation signal to the host server to inform the host server that the hardware watchdog timer in the DPU is enabled.

7. The computer-implemented method of claim 6, wherein, in response to the watchdog enablement confirmation signal, a timeout period of a timeout timer of the host watchdog service timer thread is set and the host watchdog service timer thread is enabled.

8. The computer-implemented method of claim 7, further comprising:
at the DPU, resetting the hardware watchdog timer in the DPU in response to the timer reset request from the host watchdog service timer thread, wherein the timer reset request is generated by the host watchdog service timer thread upon an expiration of the timeout timer of the host watchdog service timer thread.

9. The computer-implemented method of claim 1, wherein the DPU is connected to the host server through a Peripheral Component Interconnect Express (PCIe) interface.

10. A non-transitory computer-readable storage medium containing program instructions, wherein execution of the program instructions by one or more processors causes the one or more processors to perform steps comprising:
at a data processing unit (DPU), enabling a hardware watchdog timer in the DPU; and
at the hardware watchdog timer in the DPU, detecting that a host server that is connected to the DPU is unresponsive when the hardware watchdog timer expires without receiving a timer reset request from a host watchdog service timer thread running in the host server.

11. The non-transitory computer-readable storage medium of claim 10, wherein the steps further comprise at the hardware watchdog timer in the DPU, resetting the DPU after detecting that the host server that is connected to the DPU is unresponsive.

12. The non-transitory computer-readable storage medium of claim 10, wherein the steps further comprise at the hardware watchdog timer, transmitting an interrupt signal to the DPU after detecting that the host server that is connected to the DPU is unresponsive.

13. The non-transitory computer-readable storage medium of claim 10, wherein the steps further comprise:
at the DPU, transmitting a bootup completion indication signal to the host server to notify the host server that a bootup of the DPU is completed; and
at the DPU, transmitting a watchdog capability information signal to the host server to notify the host server of capability information of the hardware watchdog timer in the DPU.

14. The non-transitory computer-readable storage medium of claim 10, wherein at the DPU, enabling the hardware watchdog timer in the DPU comprises:
at the DPU, receiving a watchdog enablement request signal from the host server; and
upon receiving the watchdog enablement request signal, configuring a timeout period of the hardware watchdog timer and enabling the hardware watchdog timer.

15. The non-transitory computer-readable storage medium of claim 10, wherein the steps further comprise:
at the DPU, transmitting a watchdog enablement confirmation signal to the host server to inform the host server that the hardware watchdog timer in the DPU is enabled.

16. The non-transitory computer-readable storage medium of claim 15, wherein in response to the watchdog enablement confirmation signal, a timeout period of a timeout timer of the host watchdog service timer thread is set and the host watchdog service timer thread is enabled.

17. The non-transitory computer-readable storage medium of claim 16, wherein the steps further comprise:
at the DPU, resetting the hardware watchdog timer in the DPU in response to the timer reset request from the host watchdog service timer thread, wherein the timer reset request is generated by the host watchdog service timer thread upon an expiration of the timeout timer of the host watchdog service timer thread.

18. The non-transitory computer-readable storage medium of claim 10, wherein the DPU is connected to the host server through a Peripheral Component Interconnect Express (PCIe) interface.

19. A system comprising:
memory; and
at least one processor configured to:
enable a hardware watchdog timer in a data processing unit (DPU); and
detect that a host server that is connected to the DPU is unresponsive when the hardware watchdog timer expires without receiving a timer reset request from a host watchdog service timer thread running in the host server.

20. The system of claim 19, wherein the at least one processor is configured to:
reset the DPU after detecting that the host server that is connected to the DPU is unresponsive.
